(19) United States
(12) Patent Application Publication
(10) Pub. No.: US 2026/0299104 A1
(43) Pub. Date: Oct. 1, 2026

(54) ANTENNA SELECTION FOR MULTI-STAGE RADAR DETECTION

(71) Applicant: TEXAS INSTRUMENTS INCORPORATED, Dallas, TX (US)

(72) Inventors: Karthik Subburaj, Bangalore (IN); Shankar Ram Narayana Moorthy, Bangalore (IN); Bhaskar Upadhyay, Melissa, TX (US); Anil Mani, McKinney, TX (US); Pavan Korada, Visakhapatnam (IN)

(21) Appl. No.: 19/344,972

(22) Filed: Sep. 30, 2025

(30) Foreign Application Priority Data
Mar. 28, 2025 (IN) 202541029854

(51) Int. Cl. G01S 13/02

(52) U.S. Cl. CPC G01S 13/02; G01S 2013/0254; G01S 2013/0272

(57) ABSTRACT

A radar device comprises antennas, transceiver circuitry, and processing circuitry operable to direct the transceiver circuitry to, during an object detection mode, transmit a first set of radar signals and receive a second set of radar signals using a first subset of the antennas, such that the first subset of the antennas is determined based on an amount of power consumed by the radar device during activation of the first subset of the antennas. In response to detecting an object, the processing circuitry is further operable to direct the transceiver circuitry to transition to a direction detection mode and to use a second subset of the antennas to transmit a third set of radar signals and receive a fourth set of radar signals. The number of antennas in the second subset of the antennas is greater than the number of antennas in the first subset of the antennas.

### CROSS-REFERENCE TO RELATED APPLICATION

This application hereby claims the benefit of and priority to Indian Provisional Patent Application Number 202541029854, filed Mar. 28, 2025, entitled “ANTENNA SELECTION AND MULTI-STAGE DETECTION FOR LOW-POWER AUTOMOTIVE AND INDUSTRIAL RADAR”, which is hereby incorporated by reference in its entirety.

### TECHNICAL FIELD

Aspects of the disclosure are related to antennas, and in particular, to reducing the effects of coupling transmit antennas to receive antennas.

### BACKGROUND

Small form-factor antenna-on-package (AOP) radars are becoming popular in industrial and home automation markets. These radars are used in some applications to find the presence, distance, velocity, and direction of objects within a field of view. Based on one or more aspects of the object within the field of view, automation products employing such radar-based object detection may perform various tasks. For instance, based on the approach of an object within the field of view toward the automation product or point of detection, an approach alert may be transmitted to an end user. In one example, a remote camera for identifying activity within a given distance from a front door of a home may alert the homeowner to the approach of a delivery driver as the driver approaches the porch to drop off a shipped package.

In many cases, such automation products are battery powered, and conservation of battery power is desired to reduce power drain. Accordingly, a low-power radar using energy saving protocols can extend battery life and reduce the frequency of replacing batteries powering the unit.

Further, as stated above, AOP radars can have a small form factor, which often includes the placement of one or more transmit antennas and one or more receive antennas close together in an antenna array. The antennas may be formed on a device such as an AOP device. The proximity of the transmit (TX) antenna(s) to the receive (RX) antenna(s) can cause an adverse coupling of the antennas that causes inefficiency in transmit and receive radio frequency (RF) signals transmitted and received through the antenna array. This TX-RX coupling can cause a stumbling block in designing and using a low-power small form-factor AOP radar.

### SUMMARY

Disclosed herein is technology, including systems, methods, and devices for providing low-power object detection within the context of antenna-on-package (AOP) radars.

In one example embodiment, a radar device comprises antennas; transceiver circuitry coupled to the antennas; and processing circuitry coupled to the transceiver circuitry. The processing circuitry is operable to, during an object detection mode, direct the transceiver circuitry to use a first subset of the antennas to transmit a first set of radar signals and receive a second set of radar signals, wherein a number of antennas in the first subset of the antennas is less than all of the antennas and the first subset of antennas is determined based on an amount of power consumed by the radar device during activation of the first subset of antennas; detect an object based on the second set of radar signals; in response to detecting the object, direct the transceiver circuitry to transition to a direction detection mode, wherein during the direction detection mode, the processing circuitry is operable to direct the transceiver circuitry to use a second subset of the antennas to transmit a third set of radar signals and receive a fourth set of radar signals, wherein a number of the antennas in the second subset of the antennas is greater than the number of antennas in the first subset of the antennas; and detect a direction of the object based on the fourth set of radar signals.

In a second example embodiment, a method comprises configuring a radar device including an antenna array comprising multiple antennas arranged in a physical configuration formed on the radar device as an antenna-on-package assembly; identifying multiple antenna enablement configurations; determining an amount of power consumed by the radar device for each of the multiple antenna enablement configurations; and selecting a desired antenna enablement configuration from the multiple antenna enablement configurations for use in object detection based on the amount of power consumed by the radar device when using the desired antenna enablement configuration. Moreover, determining the amount of power consumed by the radar device for each of the multiple antenna enablement configurations, includes determining a noise level for each of the multiple antenna enablement configurations across a range of frequencies; determining a waveform duration for achieving a desired signal to noise ratio for each of the multiple antenna enablement configurations; and calculating the amount of power consumed by the radar device for each of the multiple antenna configurations based on the waveform duration for achieving the desired signal to noise ratio for each of the multiple antenna configurations.

In a third example embodiment, a non-transitory computer-readable medium has program instructions stored thereon and is configured to be executable by processing circuitry. The program instructions, when executed by the processing circuitry, cause the processing circuitry to receive, via an interface, configuration information related to a radar device, wherein the configuration information includes a transmit gain, a receive gain, a chirp slope, and a high-pass filter (HPF) cutoff frequency; calculate a total gain for the radar device based on the transmit gain and the receive gain; determine whether the total gain is less than or equal to a gain threshold; and in response to determining that the total gain is less than or equal to the gain threshold, configure the radar device with the transmit gain, the receive gain, the chirp slope, and the HPF cutoff frequency.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates the system of FIG. 1 in another implementation.

FIG. 3 illustrates a method in an implementation.

FIG. 4 illustrates an operational scenario in an implementation.

FIG. 5 illustrates the system of FIG. 1 in another implementation.

FIG. 6 illustrates the system of FIG. 1 in another implementation.

FIG. 7 illustrates another method in an implementation.

FIG. 8 illustrates a plurality of charts in an implementation.

FIG. 9 illustrates another plurality of charts in an implementation.

FIG. 10 illustrates another method in an implementation.

FIG. 11 illustrates another plurality of charts in an implementation.

### DETAILED DESCRIPTION

Systems, methods, and devices are disclosed herein which provide an improved process for providing low-power object detection within the context of antenna-on-package (AOP) radars. The disclosed technique(s) may be implemented in hardware, software, firmware, or a combination thereof to provide a low-power small form-factor AOP radar that is capable of finding presence, distance, velocity, and direction of objects within a field of view (FOV). Advantageously, the disclosed methodology provides a radar that reduces transmit-receive (TX-RX) antenna coupling effect that, if not tackled, can increase energy usage and degrade both transmitted and received radio frequency (RF) signals.

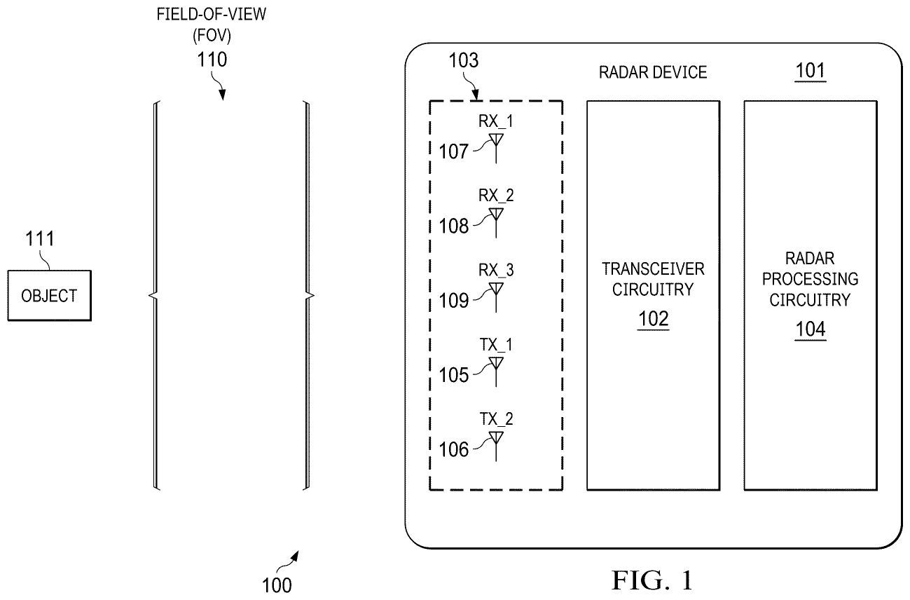

FIG. 1 illustrates a system 100 in an implementation. System 100 is representative of an exemplary system that employs an AOP device for performing various object detection and location operations. For example, system 100 may depict a system, such as an automotive system, industrial system, or consumer device, that utilizes low-power transceiver and processing circuitry to detect an object and identify one or more parameters of the object within a field-of-view. System 100 includes, but is not limited to, radar device 101 having transceiver circuitry 102, AOP subsystem 103 forming a multiple antenna array, and radar processing circuitry 104.

Transceiver circuitry 102 represents circuitry that receives transmit commands that cause transceiver circuitry 102 to transmit RF signals (e.g., chirp signals) via one or more transmitting antennas (i.e., transmit (TX) antennas 105 and 106) and to receive RF signals based on the transmitted RF signals via one or more receiving antennas (i.e., receive (RX) antennas 107, 108, and 109). Radar device 101 may be used to monitor FOV 110 for the presence of an object 111 within FOV 110. By transmitting RF signals via one or more of TX antennas 105 and 106 and receiving reflected RF signals via one or more of RX antennas 107-109, radar device 101 may detect the presence of object 111 within FOV 110.

The transmit commands may instruct transceiver circuitry 102 to begin a transmit/receive sequence based on a first antenna enablement configuration during a low power object detection stage (or operation) or to begin a transmit/receive sequence based on a second antenna enablement configuration during a higher power object direction estimation stage (or operation). In one embodiment, transceiver circuitry 102 includes memory having registers populated to direct enablement of less than all of TX antennas 105-106 and less than all of RX antennas 107-109 for saving power during the object detection stage. The memory registers may include parameters that indicate which TX and RX antennas to enable during the object detection stage as well as the desired RF signal to generate via the enabled TX antenna(s). The generated RF signal to be transmitted may include one or more different types of chirp signals (including chirp slope and duration) grouped in one or more bursts to be transmitted within a frame. The chirp signals within a burst group may be separated by an inter-chirp idle time, and multiple bursts within the frame may be separated by an inter-burst idle time. The inter-frame idle time positioned after the last burst within the frame until the start of the next frame. While the object detection stage is enabled, multiple frames may be transmitted from the enabled TX antenna(s).

During the object direction estimation stage, the generated RF signals to be transmitted may, in one embodiment, be the same as or similar to the generated RF signals during the object detection stage with the difference being the activation of additional TX antennas (e.g., all TX antennas 105-106) and additional RX antennas (e.g., all RX antennas 107-109). However, it may be beneficial to tailor the generated RF signals during the object detection stage based on a different frame such that any of the frame time, chirp signals, burst groups, and the like within the frame are optimized to facilitate estimation of the object direction. In some embodiments, all TX antennas and all RX antennas are used in the object direction estimation stage. In other embodiments, the number of TX and RX antennas used in such stage may be less than all but greater than the number of TX and RX antennas used in the object detection stage.

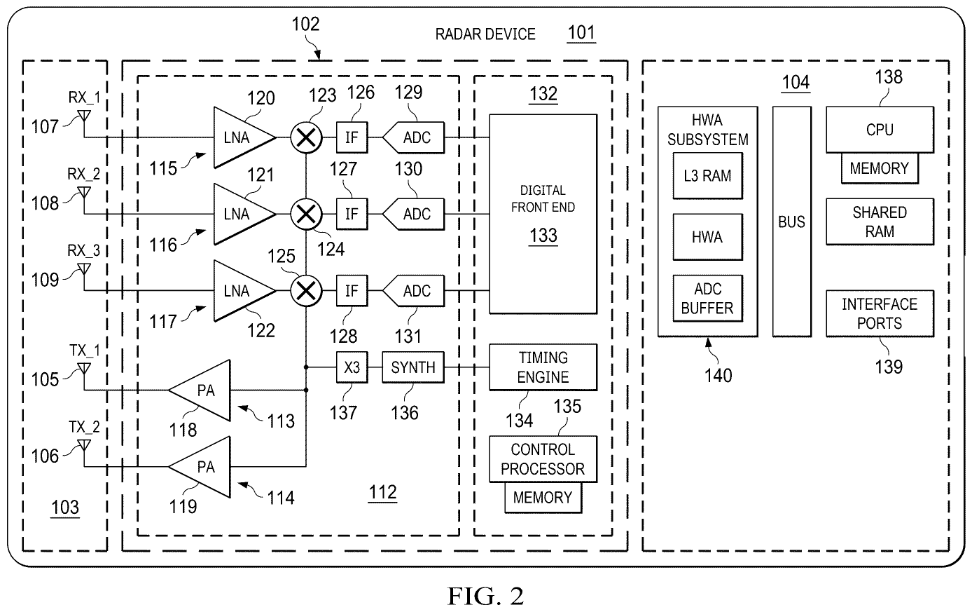

FIG. 2 illustrates details of radar device 101 of FIG. 1 in an implementation. A partial block diagram is illustrated of radar device 101. As shown, transceiver circuitry 102 includes an analog subsystem 112 that includes the RF and analog components that are required to transmit and receive the RF signals. In one example, analog subsystem 112 is a mmWave RF analog subsystem and includes transmit channels 113 and 114 and receive channels 115, 116, and 117. Transmit channels 113 and 114, respectively, include a power amplifier 118 and 119. Power amplifiers 118 and 119 are circuit elements that are responsible to deliver an RF transmission signal with desired properties and power levels to TX antennas 105 and 106, respectively. A transmit gain of the RF transmission signal is the difference between the power of the RF transmission signals provided to the inputs of power amplifiers 118 and 119 and the power of the RF transmission signals provided by the outputs of power amplifiers 118 and 119 to TX antennas 105 and 106, respectively.

Receive channels 115-117 include a respective low noise amplifier (LNA) 120-122, mixer 123-125, intermediate-frequency (IF) filter 126-128, and analog-to-digital controller (ADC) 129-131. LNAs 120-122 amplify RF signals received by RX antennas 107-109. Mixers 123-125 receive the amplified RF signals and transmitted RF signal and output an RF signal at intermediate frequency. The IF filters 126-128 filter frequencies out of the RF signals outside of the desired frequency range. The ADCs 129-131 convert the filtered analog RF signals to digital signals. A receive gain of the received RF signals is the difference between the power of the received signals provided to the inputs of LNAs 120-122 and the power of the received signals provided by the outputs of LNAs 120-122 to IF filters 126-128.

Transceiver circuitry 102 also includes front end subsystem 132 having digital front end 133, timing engine 134, and control processor 135. Front end subsystem 132 has responsibilities such as radar front-end configuration, control, and calibration routines. Control processor 135 is a processing unit that includes controls specifying which TX antennas 105 and 106 and RX antennas 107, 108, and 109 are operating during various operating modes as described herein. Timing engine 134 includes a ramp generator configured to generate an RF chirp signal that is sent to RF synthesizer 136 within the analog subsystem 112 for transmission via one or both of TX antennas 105 and 106. The RF signal output by RF synthesizer 136 is provided to a multiplier 137 to create the RF transmission signals at the desired frequency.

Radar processing circuitry 104 of radar device 101 includes central processing unit (CPU) or microcontroller 138 that serves, in one implementation, as a main processor for radar device 101. For example, CPU 138 may control operations during the object detection stages, as well as, manage the communications within radar device 101 and with systems outside radar device 101. CPU 138 analyzes received RF signals during the object detection stage to detect the presence of an object (e.g., object 111 within FOV 110 of FIG. 1) and further determines one or more parameters of the object such as its range and velocity within the FOV 110. During the object direction estimation stage, CPU 138 analyzes received RF signals to estimate or detect the direction of object 111 within FOV 110.

Communications with external devices may be performed using interface ports 139 and signals of the appropriate protocols as needed by the external devices. CPU 138 may receive, for example, various parameters form an external device via interface ports 139 for setting up operations and identifying aspects of object detection including parameters affecting the location and size of FOV 110. Hardware accelerator (HWA) subsystem 140 is included and may offload radar processing tasks such as fast Fourier transform (FFT) calculations, scaling, and compression from CPU 138.

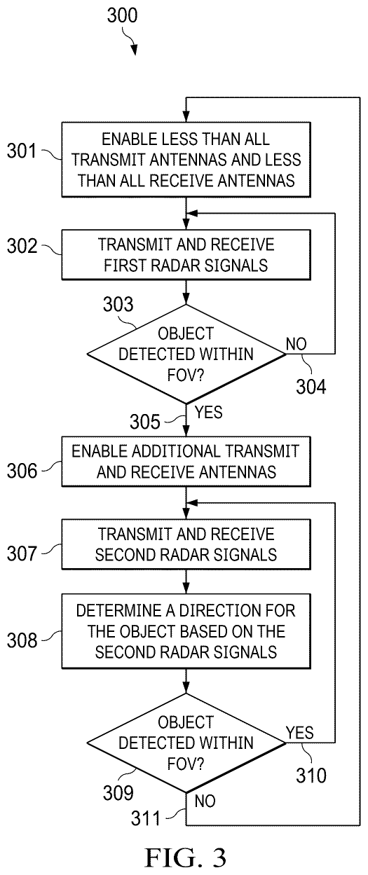

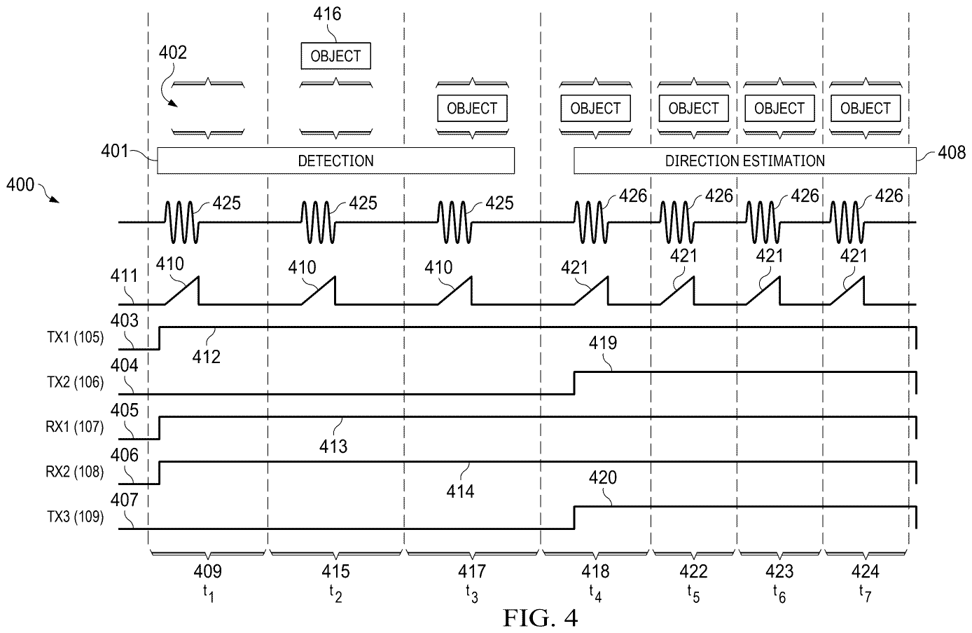

FIG. 3 illustrates control method 300 in an implementation. FIG. 4 illustrates an operational scenario 400 of control method 300 in an implementation. Referring to FIGS. 3 and 4, an object detection stage 401 is enabled in which a FOV 402 is polled to detect an object inside the FOV 402. The object detection stage 401 is a low power stage in which less than all of the TX antennas 105-106 and less than all of RX antennas 107-109 are enabled (step 301). In an implementation, TX and RX antennas 105-109 are enabled via respective enablement signals 403-407. By enabling only a subset of the TX and RX antennas 105-109, object detection within FOV 402 is accomplished using less power than a power draw necessary to enable all TX and RX antennas 105-109. In examples presented herein, during the object detection stage 401, only TX antenna 105 is enabled and powered to transmit radar signals, and only RX antennas 107 and 108 are enabled and powered to receive radar signals that are analyzed to determine the presence of an object within FOV 402. During an object direction estimation stage 408, all TX and RX antennas 105-109 are enabled to increase detection resolution. Other examples are possible consistent with the teaching that more TX and RX antennas are used in the direction estimation stage 408 than in the object detection stage.

During a first object detection time, t₁ 409, a first set of radar signals 410 of a generated RF transmission signal 411 are transmitted (step 302) through TX antenna 105 as enabled by an enablement pulse 412 of enablement signal 403. The transmitted first radar signals 410 and/or reflections thereof off of remote objects (e.g., a set of radar signals 425) are received by RX antennas 107 and 108 enabled by enablement pulses 413, 414 of enablement signals 405, 406. In the implementation shown in FIG. 4, no object is illustrated within or near FOV 402 during the first object detection time, t₁ 409.

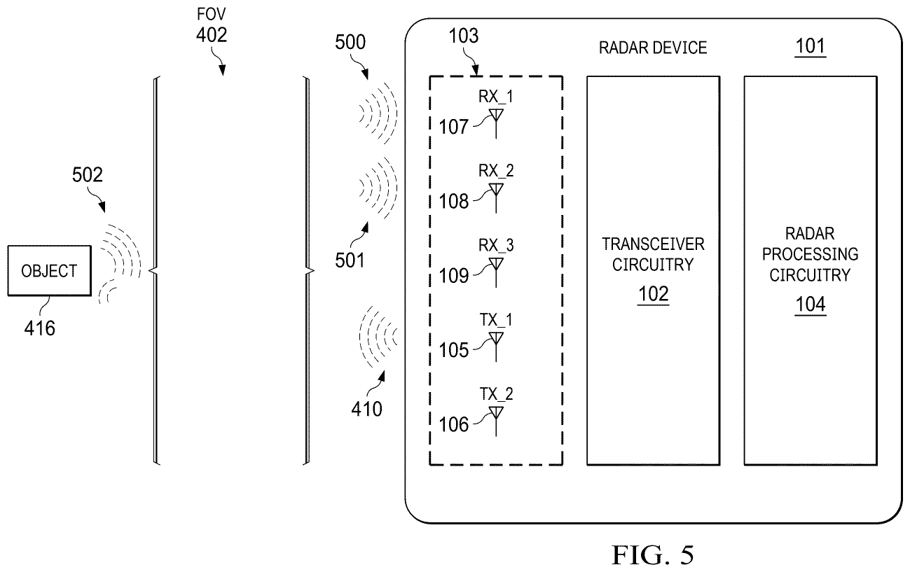

Any radar signals received through RX antennas 107 and 108 are processed by transceiver circuitry 102 and provided to CPU 138 for analysis (see FIG. 2) to detect if any object is present within FOV 402 (step 303). If no object is detected within FOV 402 (step 304), control method 300 returns to step 302 to repeat transmission of first radar signals 410 during a subsequent object detection time (e.g., second object detection time, t₂ 415). As shown in FIG. 4, an object 416 has moved near FOV 402. However, object 416 remains outside the boundaries of FOV 402. Accordingly, analysis of received radar signals through RX antennas 107 and 108 again results in a determination by CPU 138 that no object is detected within FOV 402 though object 416 has been detected. Referring to FIG. 5, radar device 101 of FIG. 1 is illustrated transmitting first radar signals 410 from TX antenna 105 and receiving radar signals 500 and 501 respectively through RX antennas 107 and 108 that may include a portion of first radar signals 410 and a portion of reflected radar signals 502 emanating from object 416 based on reflections of first radar signals 410 against object 416. Analysis of radar signals 500 and 501 by CPU 138 may allow CPU 138 to determine one or more of the presence, distance, velocity of object 416. Based on the distance, for example, object 416 may be determined to be outside of FOV 402 (as illustrated). Accordingly, object 416 is not determined to be within FOV 402 at step 303, and, returning to FIGS. 3 and 4 control method 300 returns to step 302 to transmit first radar signals 410 during a third object detection time, t₃ 417.

As shown in FIG. 4, based on an analysis of the radar signals 500 and 501 (FIG. 5) by CPU 138, object 416 is determined to be within FOV 402 (step 305). In response to determining that object 416 is within FOV 402, object detection stage 401 is ended, and object direction estimation stage 408 begins. Control method 300 enables additional TX and RX antennas (e.g., TX antenna 106 and RX antenna 109) during object direction estimation stage 408 (step 306) to increase angular resolution in determined parameters of object 416. The enablement of additional antennas increases power usage and can be used to maximize a signal-to-noise ratio (SNR) and linearity within the received radar signals.

During a fourth object detection time, t₄ 418, TX antenna 105 and RX antennas 107 and 108 remain enabled via enablement pulses 412, 413, 414. TX antenna 106 and RX antenna 109 are additionally enabled (step 307) via enablement pulses 419, 420 for transmitting and receiving radar signals. While enablement pulses 412-414 and 419-420 are shown as single enablement pulses during the respective stages 401, 408, one or all of enablement signals 403-407 may have individual enablement pulses in each object detection time 409, 415, 417, 418, 422, 423, 424 corresponding with the activation times of radar signals 410 and 421.

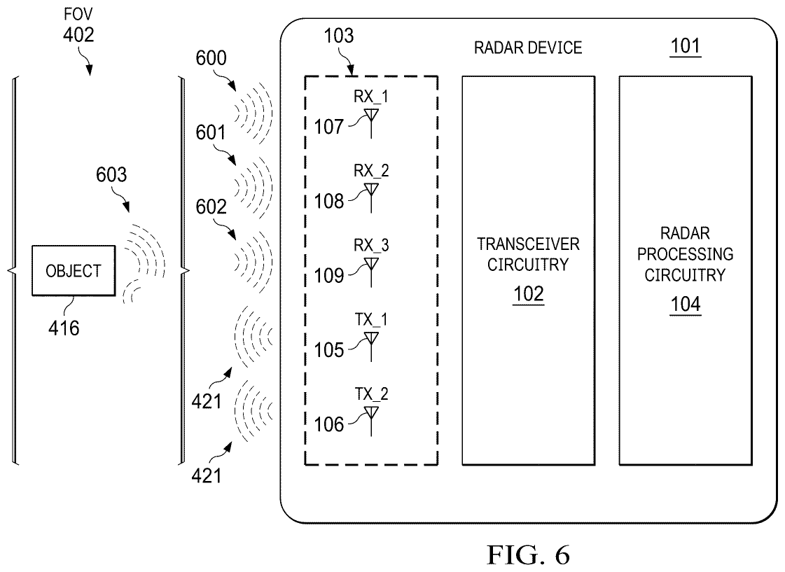

A third set of radar signals 421 are transmitted by TX antennas 105 and 106 during object direction estimation stage 408 for determination by CPU 138 of a movement direction of object 416 within FOV 402 (step 308). Referring to FIG. 6, radar device 101 of FIG. 1 is illustrated transmitting third set of radar signals 421 from TX antennas 105 and 106 and receiving radar signals 600, 601, 602 through RX antennas 107, 108, and 109. Radar signals 600-602 may include a portion of third set of radar signals 421 and a portion of reflected radar signals (e.g., a fourth set of radar signals 426 of FIG. 4) emanating from object 416 based on reflections of third set of radar signals 421 against object 416. Analysis of radar signals 600-602 by CPU 138 may allow CPU 138 to determine the direction of movement of object 416 within FOV 402 as well as the continued presence, distance, velocity of object 416 within FOV 402.

Referring back to FIGS. 3 and 4, CPU 138 determines whether object 416 remains detected within FOV 402 (step 309). While object 416 remains detected within FOV 402 (step 310), object direction estimation stage 408 remains active and enabled, and control method 300 repeats transmitting and receiving third set of radar signals 421 over successive object detection times t₅ 422, t₆ 423, and t₇ 424. In response to failing to detect object 416 within FOV 402 (step 311), the object direction estimation stage 408 terminates, and control method 300 enables object detection stage 401 (step 301) and returns to scanning FOV 402 for the presence of another object.

The decision of which TX and RX antennas 105-109 to enable or activate during object detection stage 401 when low power consumption is desired is based on an amount of power consumed by radar device 101. In general, a higher number of enabled antennas results in a higher power consumption. Further, the AOP subsystem 103 has the benefit of reducing extra space needed for antennas. However, the close proximity of the TX and RX antennas 105-109 to each other yields a significant amount of TX-RX antenna coupling. This can lead to high noise existence in RX output. Power consumption includes consideration of the number of transmitters simultaneously turned on and also on the amount of noise. A reduction in power consumption during the object detection stage 401 as presented in this disclosure includes enabling or activating only a subset of TX and RX antennas that have best performance in terms of noise for detecting presence, range and velocity.

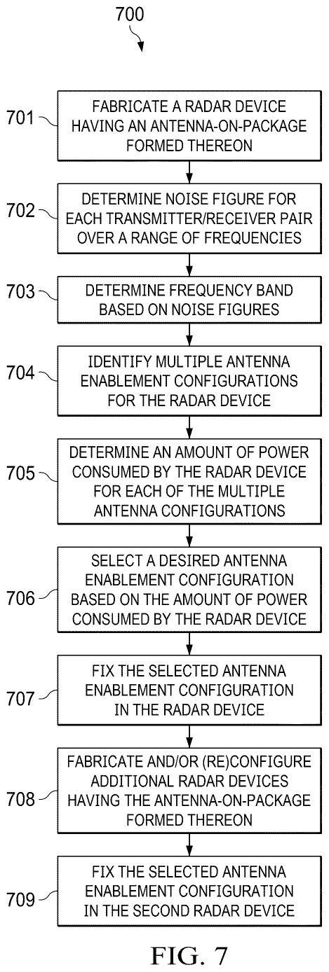

As described herein, during the object detection stage 401, less than all of the TX antennas 105-106 and less than all of the RX antennas 107-109 are used. Determining an antenna enablement configuration of less than all of the TX and RX antennas 105-109 having an optimal performance based on various low noise, low power level usage, and dwell times for use during the object detection stage 401 for one radar device, and then applying that determination to fabricate and/or (re)configure one or more additional radar devices is described below with reference to the example control method 700 illustrated in FIG. 7.

Control method 700 begins with the design and fabrication (step 701) of a first radar device such as radar device 101 described in FIGS. 1-6. In other embodiments, control method begins with configuring a first radar device. Radar device 101 has an AOP array formed thereon that includes the various TX and RX antennas 105-109. TX and RX antennas 105-109 may be formed, for example, as electrical traces on one or more layers of an antenna board substrate to which transceiver circuitry 102 and radar processing circuitry 104 are also formed and attached. It can be desirable to fabricate radar device 101 having a small form factor such that TX and RX antennas 105-109 are located sufficiently close to one another but are affected with undesirable amount of TX-RX antenna coupling as described above. In particular, an AOP device may be fabricated that includes the TX and RX antennas formed on the device. To reduce the effects of TX-RX antenna coupling on a small form factor AOP array and to reduce power consumption during a low power mode such as during the object detection stage 401, an optimal antenna enablement configuration and an optimum range of frequency are determined from a plurality of antenna enablement configurations where the optimal configuration optimizes low power consumption and signal quality (e.g., SNR).

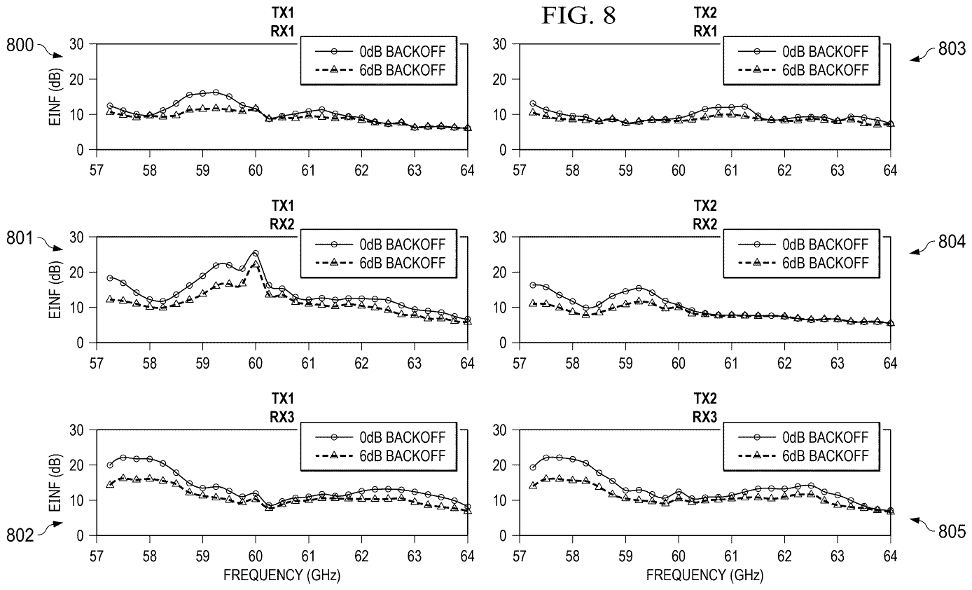

Determining a desirable low power consumption includes determining (step 702) a noise figure for each transmitter/receiver pair of the fabricated device (e.g., step 701) over a range of frequencies. An effective isotropic noise figure (EINF) is measured across various radio frequencies while energizing different TX/RX subsets of the TX and RX antennas 105-109 of the fabricated device. With regard to the antenna coupling in AOP radar, uncorrelated phase noise leads to an increase in noise figure that varies across the radio frequencies. FIG. 8 illustrates a plurality of charts in an implementation of measuring EINF values across radio frequencies between 57 GHz and 64 GHz. A first chart 800 shows EINF values measured while energizing TX antenna 105 (TX1) and RX antenna 107 (RX1). None of the other antennas (e.g., 106 or 108, 109) are energized. A second chart 801 shows EINF values measured while energizing TX antenna 105 and RX antenna 108 (RX2). Third chart 802 shows EINF values measured while energizing TX antenna 105 and RX antenna 109 (RX3). Additional charts 803-805 show shows EINF values measured while energizing TX antenna 106 (TX2) and respective RX antennas 107-109. Referring to FIGS. 7 and 8, a frequency band is determined (step 703) based on the measured EINF values of the data shown in charts 800-805. In one example, a range of 63-64 GHz is chosen based on the behavior of the measured EINF values.

As shown in control method 700 of FIG. 7, multiple antenna enablement configurations of TX and RX antennas 105-109 are identified (step 704). Each enablement configuration represents an enablement of less than all of TX and RX antennas 105-109. For example, the multiple antenna enablement configurations can include each of the individual enablement configurations shown in charts 800-805. Additional enablement configurations include enablement of one of TX antennas 105 and 106 and combinations of multiple RX antennas 107-109). Examples of enablement configurations are shown below in Table 1.

TABLE 1

| En. Config. | TX1 | TX2 | RX1 | RX2 | RX3 |
|---|---|---|---|---|---|
| 1 | x | | x | | |
| 2 | x | | | x | |
| 3 | x | | | | x |
| 4 | x | | x | x | |
| 5 | x | | x | | x |
| 6 | x | | | x | x |
| 7 | x | | x | x | x |
| 8 | | x | x | | |
| 9 | | x | | x | |
| 10 | | x | | | x |
| 11 | | x | x | x | |
| 12 | | x | x | | x |
| 13 | | x | | x | x |
| 14 | | x | x | x | x |

Each enablement configuration in Table 1 energizes some, but not all, of the TX and RX antennas 105-109, where enablement is represented by a ‘x’. In a low power mode, it can be assumed that energizing less than all of the antennas will conserve some power.

However, it cannot be assumed that only having a single TX antenna and single RX antenna presents the best enablement configuration. An analysis of the different enablement configurations can be used to determine (step 705) an amount of power consumed by the radar device for each of the multiple antenna configurations. Step 705 includes determining an overall system noise figure for one or more of the enablement configurations. The system noise figure (System NF) can be determined by the following equation:

$$System N F = 10 \times log 10 ( {\sum }_{n} 1 {0}^{\frac{RXn \_ NF}{10}} ) - 20 \times log 10 ( NUM\_RX ) \qquad ( 1 )$$

Such that in Equation (1) RXn_NF is within the 63-64 GHz RF range determined in step 703 and NUM_RX is the number of receivers enabled in the enablement configuration. Sample System NF values are illustrated in Table 2 below:

TABLE 2

| | 1TX 3RX | 1TX 2RX | 1TX 1RX |
|---|---|---|---|
| TX1 | 7.5 dB | 6.7 dB (RX1, RX2) | 8 dB (RX1) |
| TX2 | 6.4 dB | 7.7 dB (RX1, RX2) | 9 dB (RX2) |

For a required detection SNR, different TX/RX combinations will need different waveform duration or dwell times due to differences in their effective isotropic noise figures. For example, TX/RX combinations with higher system noise figures will need longer dwell times to achieve a SNR similar to that of lower system noise figure TX/RX configuration, thus consuming more power. In Table 2, the lowest system noise figure (e.g., 6.4 dB) corresponds with enablement configuration 14 of Table 1, where TX antenna 106 and all three RX antennas 107-109 are enabled. The system noise figure value of enablement configuration 14 (e.g., 6.4 dB) is used as a baseline case (SysNF_{1T3R}) to predict the required dwell times in the other enablement configurations to achieve a similar SNR as that of enablement configuration 14.

$$Dwell time = {10}^{0.1 \times ( {SysNF}_{1 TnR} - {SysNF}_{1 T 3 R} )} \qquad ( 2 )$$

Based on the examples herein, SysNF_{1T3R} in Equation (2) equals 6.4, and SysNF_{1TnR} equals the system NF value for the enablement configuration to be normalized. The dwell times of Table 2 (with enablement configuration 14 normalized to 1.00) are illustrated in Table 3 below:

TABLE 3

| | 1TX 3RX | 1TX 2RX | 1TX 1RX |
|---|---|---|---|
| TX1 | 1.29 | 1.07 | 1.45 |
| TX2 | 1.00 | 1.35 | 1.82 |

In addition to using enablement configuration 14 as a baseline to normalize the dwell times of the other enablement configurations for the values in Table 3, enablement configuration 14 is also used as a baseline to measure power usage in the fabricated device (step 701) during a low power transceiver operation enabling the TX and RX antennas 106-109 of enablement configuration 14. To measure the power usage, an example use case is chosen to establish common parameters for testing. For example, a target chirp frame frequency is chosen (e.g., 3 Hz) for use within the chosen 63-64 GHz band. Using these parameters, the radar device is powered and operated according to a low power operation in which the TX and RX antennas 106-109 are enabled during the transmission and reception operations.

Based on the measured power usage for the 1TX 3RX energization of TX antenna 106 and RX antennas 107-109 (e.g., enablement configuration 14), the energy usage corresponding to the other enablement configurations can be derived. In an example, active power consumed for a given period of time of the 1TX 3RX energization of enablement configuration 14 may be 800 mW. It can be derived that the 1TX 3RX energization of enablement configuration 7, where TX antenna 105 and RX antennas 107-109 are energized for the same time period will consume the same energy. Other enablement configurations enabling either TX antenna 105 or 106 with any two of the RX antennas 107-109 may be derived as consuming 720 mW for the same time period. Enabling either TX antenna 105 or 106 with any one of the RX antennas 107-109 may be derived as consuming 690 mW for the same time period.

The actual power usage during the low power transmission and reception in a use case may differ as chirp frame rates, chirp bursts, chirp slopes, and the like within the transmitted and received RF signals differ among different use cases. For example, a smaller cross-section expected target to be detected within a given FOV may enable higher power usage due to higher energization of the antennas 105-109 than a larger cross-section target within the same FOV. Accordingly, a constant scalar factor, k, may be useful in determining amounts of power consumed by the radar device for the use case(s) expected. Based on the actual and derived power usage based on the measurement time period (e.g., the time period resulting in measuring 800 mW for enablement configuration 14), power usage for a given use case may be calculated according to the following equation:

$$Use case power = k \times T F \times active power \qquad ( 3 )$$

Such that in Equation (3), TF is the time factor from Table 2, and the active power is the measured or derived power determined above. Based on the calculations of Equation (3), the following table illustrates example power consumption values of the enablement configurations of Table 1 for an exemplary 3 Hz use case:

TABLE 4

| | 1TX 3RX | 1TX 2RX | 1TX 1RX |
|---|---|---|---|
| TX1 | 1.031 mW | 0.771 mW (RX1, RX2) | 0.997 mw (RX1) |
| TX2 | 0.800 mW | 0.971 mW (RX1, RX2) | 1.255 mW (RX2) |

Table 5 illustrates a combination of data from Tables 1-4 into a single table.

TABLE 5

| Enablement | | | Active | Total power |
|---|---|---|---|---|
| (Antenna) | | Time | power | consumption |
| configurations | EINF | factor | consumed | (3 Hz use case) |
| 1 (TX1 RX1) | 8.0 dB | 1.45 | 690 mW | 0.997 mW (derived) |
| 4 (TX1 RX1, 2) | 6.7 dB | 1.07 | 720 mW | 0.771 mW (derived) |
| 7 (TX1 RX1, 2, 3) | 7.5 dB | 1.29 | 800 mW | 1.031 mW (derived) |
| 8 (TX2 RX1) | 9.0 dB | 1.82 | 690 mW | 1.255 mW (derived) |
| 11 (TX2 RX1, 2) | 7.7 dB | 1.35 | 720 mW | 0.971 mW (derived) |
| 14 (TX2 RX1, 2, 3) | 6.4 dB | 1.00 | 800 mW | 0.800 mW (baseline |
| | | | | measured) |

The measured and derived total power consumption values of Table 5 determined in step 705 of control method 700 provides that, based on the above analysis of power to be consumed by the radar device during a lower power object detection mode, enablement configuration 4 shows the lowest total power consumption for the 3 Hz use case. While a particular use case (e.g., 3 Hz) is used to calculate and derive the total power consumption data, it is expected that the total power consumed in other use cases will yield similar analyses showing that the subset of antennas enabled for best low power consumption also correspond to enablement configuration 4 (e.g., TX antenna 105 and RX antennas 107-108). Accordingly, enablement configuration 4 is selected (step 706) as the desired antenna configuration to be used during a low power mode based on the amount of power consumed by the radar device. The selected enablement configuration is fixed (step 707) in the fabricated radar device (e.g., step 701) as the antenna configuration to be used during a low power mode used to detect objects as described herein. Fixing the selected enablement configuration may include, for example, entering data corresponding to the selected enablement configuration within registers or other memory of control processor 135 (FIG. 2) responsible for enabling antennas during the object detection stage 401 (FIG. 4).

After determining and selecting the desired antenna enablement configuration using the first radar device (e.g., step 701), one or more additional radar devices may be fabricated and/or (re)configured to use the desired antenna enablement configuration of the first radar device. based on the same design and fabrication process are expected to exhibit similar total power consumptions as the first radar device. As such, one or more additional radar devices fabricated or (re)configured (step 708) may reuse the information obtained from the processing applied to the first radar device to determine the desired antenna enablement configuration selected (e.g., step 706) in the processing of the first radar device. To that end, each additional radar device may store such information in memory (step 709) for later use. Advantageously, each additional radar device can then operate similarly to the first radar device without having to perform steps 702-706.

Transmit/receive coupling phase and magnitude varies with RF output. The coupling manifests as a low frequency wave in received RF signals with a frequency dependent on the chirp slope. Attenuation of the coupled signal can be accomplished via a high pass filter (e.g., IF filters 126-128 of FIG. 2) in the analog receive channel (e.g., receive channels 116 and 117). The cutoff frequency in the high pass filter is programmable.

Saturation can occur in analog-to-digital conversion operations (e.g., in ADCs 129-131 of FIG. 2) in near-range use case applications where a high chirp slope and low high pass filter cutoff are used during enablement of all TX and RX antennas 105-109 such as during the object direction estimation stage 408, for example. The high chirp slope and low cutoff values promote a high coupling among the antennas.

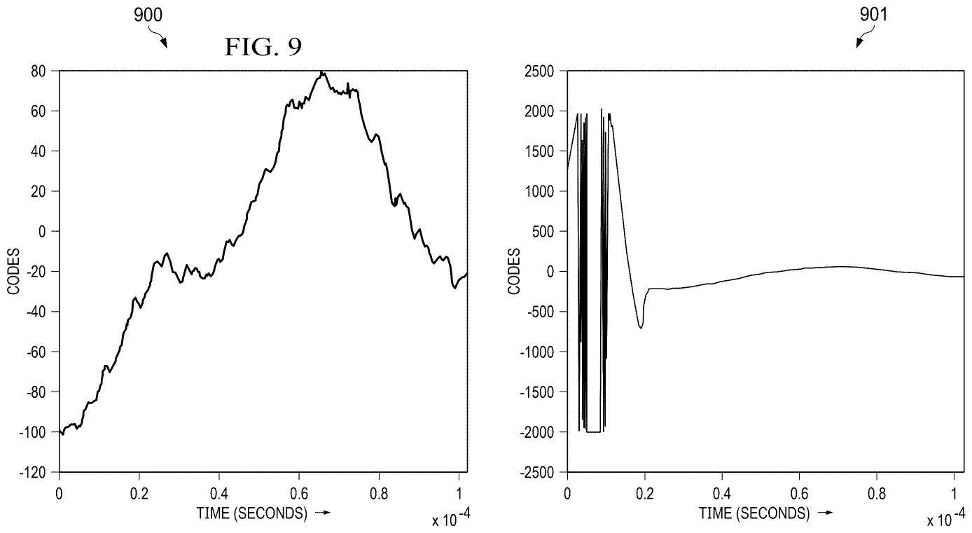

FIG. 9 illustrates a signal chart 900 showing analog-to-digital conversion output experiencing little to no saturation. Alternatively, signal chart 901 shows analog-to-digital conversion output experiencing a high amount of saturation. It can be estimated that a swing in the output values within a code range between −120 and +120 yields data with minimal to no saturation effects (e.g., signal chart 900) while a swing in the output values greater than range between −1200 and +1200 yields data with high saturation effects (e.g., signal chart 901). Saturation can lead to signal corruption and loss of data. To avoid ADC data saturation in the received RF data, parameters such as transmitter and receiver gains, signal chirp slopes, and HPF cutoff frequencies can be optimally chosen to minimize or avoid saturation issues.

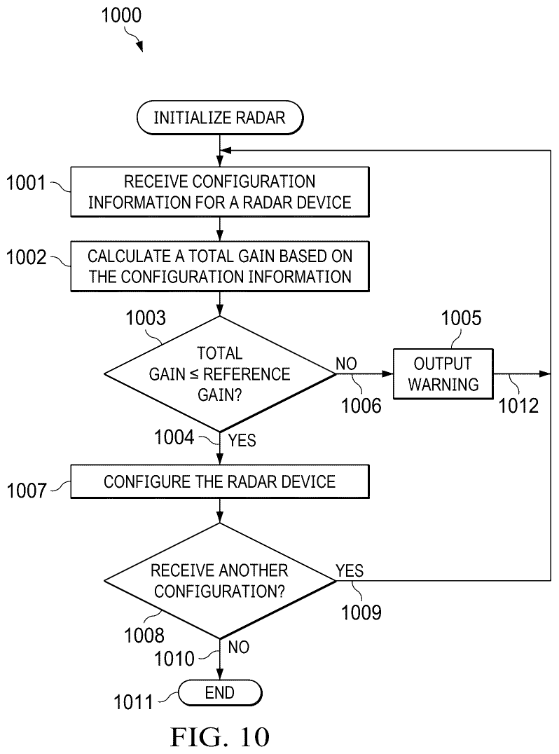

FIG. 10 illustrates a control method 1000 in an implementation. Control method 1000 is representative of a technique for reducing a likelihood of saturation in received RF signals by receiving and evaluating radar transceiver configuration data and estimating ADC saturation based thereon. Control method 1000 begins initializing the radar, followed by receipt of configuration information for a radar device (step 1001). The configuration information includes a chirp slope to be used in transmit and receive signals such as during the object direction estimation stage 408 discussed above and includes a high pass filter (HPF) cutoff frequency to be used by the analog-to-digital converters in converting the received signals to digital values. The configuration information includes desired transmit and receive gains desired. The TX and RX gains, chirp slope, and HPF cutoff frequency are provided as received configuration information by a user such as through inputs received via a software development kit (SDK) provided by a manufacturer or seller of the radar device to a user, e.g., a customer. The inputs allow the user to tailor the use case of the radar device based on the projected scenarios in which the radar device will be used to detect objects and to determine other parameters of the object such as those described herein.

The received configuration information is used in a comparison to calculate a total gain based on the configuration information (step 1002). The calculation is performed using the following equation:

$$Total gain \leq Reference gain \qquad ( 4 )$$

$$where :$$

$$Total gain = RX gain + TX gain \qquad ( 5 )$$

$$Reference gain = A - B + C - D \qquad ( 6 )$$

$$A = Reference Saturation Threshold ( in dB ) \qquad ( 7 )$$

$$B = 20 \times log 10 ( \frac{chirp slope}{Reference chirp slope} ) \qquad ( 8 )$$

$$C = 20 \times log 10 ( \frac{HPF Cutoff Frequency}{Reference Cutoff Frequency} ) \qquad ( 9 )$$

$$D = 20 \times log 10 ( Number of simultaneous enabled TX ) \qquad ( 10 )$$

As stated above, the RX gain and the TX gain on the left side of the inequality are provided by user input. Also, the chirp slope and the HPF Cutoff Frequency in the numerators of the fractions of equations (8) and (9) are also provided by user input. The reference values (e.g., Reference Saturation Threshold of Equation (7), Reference chirp slope of Equation (8), and Reference Cutoff Frequency of Equation (9) are determined based on empirical testing. To determine the Reference Saturation Threshold of Equation (7), a Reference chirp slope and a Reference Cutoff Frequency are chosen based on a base use case including enabling a given number of TX antennas. When used in a use case enabling all of the TX antennas, the number of simultaneously enabled antennas equals the number of TX antennas. Then, using these parameters, various TX and RX gain values are programmed in the radar device while testing the received RF data for saturation. When saturation occurs, the reference saturation threshold value (in dB) is determined. Later evaluation of Equation (4) includes using the determined reference chirp slope, reference cutoff frequency, reference saturation threshold, and the total number of TX antennas enabled in reference case as fixed values not affected by user input.

Equation (4) is evaluated (step 1003) to determine whether the four input values provided via the SDK satisfy the inequality. In particular, a total gain value is evaluated against a reference gain value. If the total gain is not less than or equal to the reference gain (step 1006), a warning is output (step 1005), in which case the control method 1000 returns (step 1012) to step 1001, where a new set of configuration information is received, in which at least one item of configuration information is different from the previously received configuration information. From there, the process continues with the new set of configuration information as explained above. In response to the total gain being less than or equal to the reference gain (step 1004) for the initial set of configuration information or other configuration information of a later iteration, the radar device is configured (step 1007) via the SDK with the values provided via the user input. The test of the input values via Equation (4) is not an absolute determination that saturation based on the received RF signals will not occur. Instead, such saturation is expected to be minimal, though no saturation is highly desired. If the warning is ignored such that the radar device is configured with values likely to produce saturation based on the received RF signals, the radar device will still operate according to the values, and saturation can be expected.

In some implementations, additional configurations may be received via user inputs provided to the SDK to allow for multiple operating scenarios. Such scenarios may be chosen based on one or more use cases provided to the radar device such that object detection may be accomplished using different configurations. In an exemplary implementation, a radar device configured to monitor a fixed field of view may not need multiple detection configurations. This type of radar device may be incorporated into a system of monitoring the FOV from a fixed position such as a house porch or a warehouse, for example. In another exemplary implementation, a radar device may be affixed to a movable base such as an automobile or a bicycle. With a movable base, it may be desirable to monitor a FOV at a certain position from the base to detect objects that enter the FOV while the base is moving. In one example, it may be desirable at higher speeds of the base to detect objects far away from the base, while lower speeds may allow for object detection closer to the base. In this manner, a first configuration may be received via the SDK to establish a far-field FOV in one environment, and a second configuration may be received to establish a near-field FOV in another environment. Based on an input to the radar device (e.g., such as via CPU 138 of FIG. 2) communicated from a system of the movable base (e.g., an automobile controller configured to detect automobile speed and select the desired FOV based on the speed) and based on the current environment, the radar device may engage first or second (or additional) configurations altering the object detection operations.

Thus, in response to configuring the radar device (step 1007), control method 1000 determines whether another configuration including user input parameters has been received (step 1008). In response to receiving another configuration (step 1009), steps 1002-1007 are processed as needed to address the additional configuration parameters. In response to receiving no additional configuration (step 1010), control method 1000 ends (step 1011).

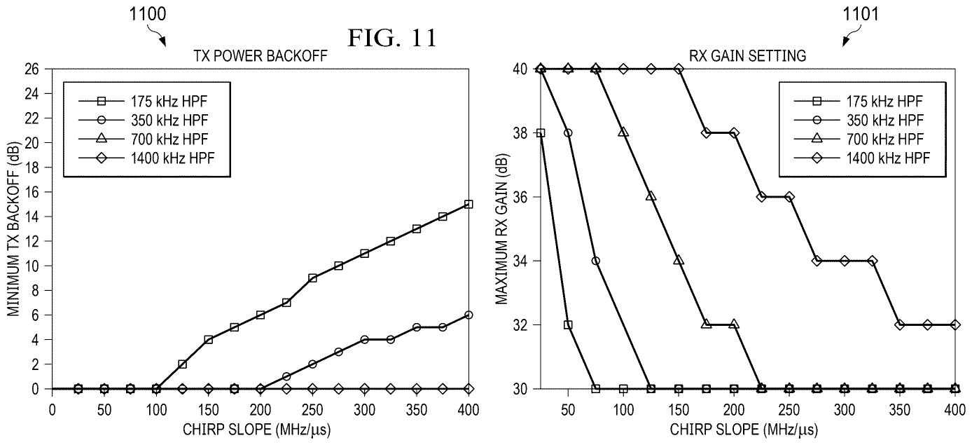

Referring to FIG. 11, a plurality of charts are illustrated in an implementation. A first chart 1100 illustrates a plurality of HPF cutoff frequency curves (e.g., 175 kHz, 350 kHz, 700 kHz, 1400 kHz) plotted on a graph of chirp slopes (horizontal axis) and minimum TX gain values (vertical axis). A second chart 1101 illustrates a plurality of HPF cutoff frequency curves (e.g., 175 kHz, 350 kHz, 700 kHz, 1400 kHz) plotted on a graph of chirp slopes (horizontal axis) and maximum RX gain values (vertical axis). Based on a desired use case including a predetermined HPF cutoff frequency and a predetermined chirp slope, charts 1100 and 1101 can be consulted to determine TX and RX gain values that should satisfy Equation (4) at the predetermined HPF cutoff frequency and chirp slope.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A radar device comprising:
antennas;
transceiver circuitry coupled to the antennas; and
processing circuitry coupled to the transceiver circuitry, wherein the processing circuitry is operable to:
during an object detection mode, direct the transceiver circuitry to use a first subset of the antennas to transmit a first set of radar signals and receive a second set of radar signals, wherein a number of antennas in the first subset of the antennas is less than all of the antennas and the first subset of antennas is determined based on an amount of power consumed by the radar device during activation of the first subset of antennas;
detect an object based on the second set of radar signals;
in response to detecting the object, direct the transceiver circuitry to transition to a direction detection mode, wherein during the direction detection mode, the processing circuitry is operable to direct the transceiver circuitry to use a second subset of the antennas to transmit a third set of radar signals and receive a fourth set of radar signals, wherein a number of the antennas in the second subset of the antennas is greater than the number of antennas in the first subset of the antennas; and
detect a direction of the object based on the fourth set of radar signals.

2. The radar device of claim 1, wherein the first subset of the antennas is chosen from multiple antenna enablement configurations, and wherein the radar device is configured to consume less power using the first subset of the antennas than using any of the other multiple antenna enablement configurations including the second subset of the antennas.

3. The radar device of claim 2, wherein a desired antenna enablement configuration includes an enablement configuration and an optimum range of frequency that minimizes the amount of power consumed by the radar device.

4. The radar device of claim 2, wherein the amount of power consumed by the radar device using the first subset of the antennas is determined based on a noise level and a waveform duration for achieving a desired signal to noise ratio.

5. The radar device of claim 1, wherein a gain for the first set of antennas does not exceed a gain threshold determined based on a reference saturation threshold for the first set of antennas, and a gain for the second set of antennas does not exceed a gain threshold determined based on a reference saturation threshold for the second set of antennas, wherein the gain for the first set of antennas includes a summation of a transmit gain and a receive gain.

6. The radar device of claim 5, wherein the gain threshold is determined based on a reference saturation threshold, and the reference saturation threshold is determined based on a reference chirp slope and a reference high-pass filter cutoff frequency.

7. The radar device of claim 6, wherein the gain threshold is further determined based on programmable parameters that include a chirp slope and an HPF cutoff frequency.

8. The radar device of claim 7, wherein the processing circuitry adjusts the programmable parameters based on a current environment.

9. The radar device of claim 1, wherein the processing circuitry further directs the transceiver circuitry to, during the object detection mode, detect a distance of the object and a velocity of the object based on the second set of radar signals.

10. A method comprising:
configuring a radar device including an antenna array comprising multiple antennas arranged in a physical configuration formed on the radar device as an antenna-on-package assembly;
identifying multiple antenna enablement configurations;
determining an amount of power consumed by the radar device for each of the multiple antenna enablement configurations; and
selecting a desired antenna enablement configuration from the multiple antenna enablement configurations for use in object detection based on the amount of power consumed by the radar device when using the desired antenna enablement configuration;
wherein determining the amount of power consumed by the radar device for each of the multiple antenna enablement configurations, includes:
determining a noise level for each of the multiple antenna enablement configurations across a range of frequencies;
determining a waveform duration for achieving a desired signal to noise ratio for each of the multiple antenna enablement configurations; and
calculating the amount of power consumed by the radar device for each of the multiple antenna configurations based on the waveform duration for achieving the desired signal to noise ratio for each of the multiple antenna configurations.

11. The method of claim 10, wherein the radar device is a first radar device, the method further comprising:
configuring a second radar device having an antenna array comprising multiple antennas arranged in the physical configuration; and
setting, in the second radar device, the desired antenna enablement configuration for use in object detection by the second radar device.

12. The method of claim 10, wherein the desired antenna enablement configuration includes an enablement configuration and an optimum range of frequency that minimizes the amount of power consumed by the radar device.

13. The method of claim 10, further comprising:
determining a reference saturation threshold for the multiple antennas; and
determining a gain threshold for the multiple antennas based on the reference saturation threshold.

14. The method of claim 13, wherein to determine the reference saturation threshold for the multiple antennas, the method comprises:
determining a reference chirp slope for the multiple antennas;
determining a reference high-pass filter (HPF) cutoff frequency for the multiple antennas; and
calculating the reference saturation threshold based on the reference chirp slope and the reference HPF cutoff frequency.

15. The method of claim 14, wherein determining the gain threshold is further based on programmable parameters that include a chirp slope and an HPF cutoff frequency.

16. The method of claim 15, wherein a summation of a transmit gain for the desired antenna enablement configuration does not exceed a gain threshold.

17. A non-transitory computer-readable medium having program instructions stored thereon is configured to be executable by processing circuitry, wherein the program instructions, when executed by the processing circuitry, cause the processing circuitry to:
receive, via an interface, configuration information related to a radar device, wherein the configuration information includes a transmit gain, a receive gain, a chirp slope, and a high-pass filter (HPF) cutoff frequency;
calculate a total gain for the radar device based on the transmit gain and the receive gain;
determine whether the total gain is less than or equal to a gain threshold; and
in response to determining that the total gain is less than or equal to the gain threshold, configure the radar device with the transmit gain, the receive gain, the chirp slope, and the HPF cutoff frequency.

18. The non-transitory computer-readable medium of claim 17, wherein to calculate the total gain, the program instructions cause the processing circuitry to perform a summation between the transmit gain and the receive gain.

19. The non-transitory computer-readable medium of claim 18, wherein the gain threshold is based on a reference saturation threshold, a reference chirp slope, a reference HPF cutoff frequency, the chirp slope, and the HPF cutoff frequency.

20. The non-transitory computer-readable medium of claim 19, wherein the reference saturation threshold is based on the reference chirp slope and the reference HPF cutoff frequency.
